(19) United States
(12) Patent Application Publication
(10) Pub. No.: US 2010/0177275 A1
(43) Pub. Date: Jul. 15, 2010

(54) RIMLESS EYEGLASSES

(76) Inventor: Stefan Kastner, Brescia (IT)

Correspondence Address: MCGLEW & TUTTLE, PC, P.O. BOX 9227, SCARBOROUGH STATION, SCARBOROUGH, NY, 10510-9227, US

(21) Appl. No.: 12/063,607

(22) PCT Filed: May 22, 2006
(86) PCT No.: PCT/IT06/00379

§ 371 Date: Feb. 12, 2008

(30) Foreign Application Priority Data
Aug. 18, 2005 (IT) BS2005A000100

(51) Int. Cl. G02C 1/02

(52) U.S. Cl. 351/110

(57) ABSTRACT

The invention concerns rimless eyeglasses in which each lens integrally comprises on the nose side, connection elements made to couple together to connect the two lenses with the aid of a blocking element which houses them forming a nose bridge. On the temple side each lens has a templet to which the arm is hinged. The templets and the arms of the eyeglasses can have means for interlocking them together to protect the integrity of the hinge when the arms are subjected to incorrect forces.

### FIELD OF INVENTION

This invention concerns the eyeglasses field and in particular the rimless or so-called glasant version eyeglasses, both for reading, for long-sightedness, plus goggles and sunglasses.

### STATE OF THE ART

Eyeglasses can be with or without rimmed lenses. In particular, rimless eyeglasses are usually produced using flat edge chamfer grinding of the lenses, drilling each lens in the temple and nose edges followed by inserting and blocking of the screws, pins or the like in the drilled holes of the lenses to connect and fix the latter to the centre nose bridge and lateral arms.

When using this method of production however, assembly of a pair of spectacles is extremely laborious and costly and furthermore the screws, pins or the like, besides forming a weak point in the structure of the spectacles, are always on the inside of the lenses, occupying two parts of the temple and nose areas and correspondingly limiting the useful field of vision.

### OBJECTS AND SUMMARY OF THE INVENTION

One object of this invention is on the one hand to create the conditions to avoid the above criticized drawbacks regarding the construction of the rimless eyeglasses and therefore to propose spectacles that do not require any drilling of the lenses and that, although being rimless, do not suffer any impingement nor limitation of the field of vision, guaranteeing maximum comfort and safety for the wearer.

Another object of the invention is to provide lenses equipped with means for connecting them to the arms and which advantageously can be cast from polymeric material available on the market having high optical and mechanical characteristics, thanks to the possibility of establishing the sections of the end parts of the lenses on the nose and temple sides for a correct distribution of the polymeric material in a mould.

A further object of the invention is to provide lenses for eyeglasses prepared for their simple and direct mechanical coupling, also in an irreversible form, with complementary elements, such as the nose bridge and arms, without the need either for further machining or particular equipment; in addition the nose bridge and arms can be made with the same material used to produce the lenses.

Yet another object of the invention is therefore to propose rimless eyeglasses simple to produce, solid in structure and at a competitive cost even compared with eyeglasses of the same type, and the assembly of which can be carried out directly by the optician involving limited labour, once the ophthalmic or protective lenses, even different, have been selected based on the sight imperfections of the user and request of the latter as regards to material, shape and colour of the components forming the eyeglasses.

These objects and implicit advantages deriving from them are achieved, according to the invention, with an improved, rimless pair of eyeglasses comprising two lenses, a nose bridge and two arms, in which each lens is cast and has a connecting piece protruding from the nose edge and a templet projecting from the temple side, both integral with the lens and in which the connecting element of one lens fits complementarily with the connecting element of the other lens with the help of a blocking element which encloses them to form the nose bridge, and where each templet is prepared to receive the hinge of the relative arm.

The connecting element on the nose side of each lens can be differently shaped, and the blocking element can be provided to simply enclose the connecting elements, avoiding uncoupling, or to actively take part in the blocking function in association with other fixing devices.

On the other hand, the templet on the temple side of each lens is prepared to hinge onto an arm simply by inserting a pin which can be force fitted.

Furthermore, according to another innovative aspect, each templet and relative arm are shaped to be interlocked complementally when the arm is unfolded and in line with the templet, resulting in a definite improvement in the mechanical resistance of the spectacles at the hinge point between the templets and arms, a point which is notoriously less thick and weakest area on spectacles especially if made of plastic.

Sometimes a cord or chain is connected to the arms so that when the spectacles are not being used they hang around the neck of the user. In this condition however, the spectacles are subject to, even if unintentionally, stress and compression which can lead to the arms flexing and bending, generating incorrect forces that are exerted directly on the parts of the hinge with the risk of them breaking.

The expedient to couple by interlocking each templet with its relative arm is directed at eliminating this risk in that, the forces the arm can be subject to are no longer exerted on the hinge zone but on the section accommodating the templet adjacent to the lens, a section that is normally much thicker and consequently more resistant than the parts of the hinge the pin passes through.

### BRIEF DESCRIPTION OF THE DRAWINGS

The invention will however be described in more detail with reference to the enclosed indicative and not limiting drawings, in which:

FIG. 1 shows an exploded view of the components of a pair of spectacles according to a production method of the invention;

FIG. 1a shows a circled detail in FIG. 1, enlarged to show the connecting elements between the lenses and the nose bridge;

FIG. 1b shows the joining of two lenses with the connection elements of FIG. 1a;

FIG. 1c shows a pair of spectacles assembled starting from the components in FIG. 1;

FIG. 2 shows another manufacturing method of the connection elements of the lenses;

FIG. 3 shows a cross section of the connection of two lenses with the connection elements in FIG. 2;

FIG. 4 shows a further method of production of the connection elements;

FIG. 5 shows a cross section of the connection of the two lenses with the connection elements of FIG. 4;

FIG. 6 shows still another method of production of the connection elements;

FIG. 7 shows a cross section of the connection of the two lenses with the connection elements of FIG. 6; and

FIGS. 8 and 9 show the views from two angles of the connecting devices and connection by interlocking of an arm with the templet of a lens.

### DETAILED DESCRIPTION OF THE INVENTION

As shown, the spectacles comprise two lenses 10, 11, left and right, that according to optical requirements can be analogous or different and are however prepared with two devices to be connected in correspondence with a nose bridge 12 and two arms 13.

The lenses 10, 11 can be made of a polymeric material for optical use, usable with any moulding technique, which advantageously enables the production of any shape of finished lenses, with different thicknesses depending on the optical parameters required and the possibility of equipping the lenses with the accessories parts. In fact the lenses are made using this technique and, according to the invention each are equipped with a connection element on the nose side to form a connection with the nose bridge and with a templet 26 protruding from the temple zone to form a connection with the arm, both elements being integral with the lenses and formed during casting.

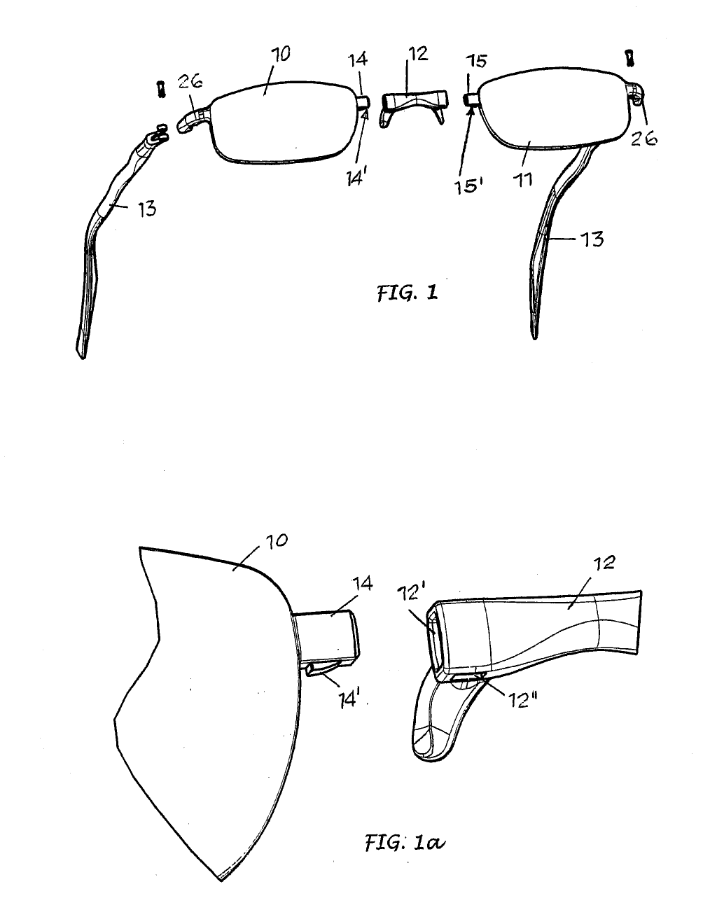

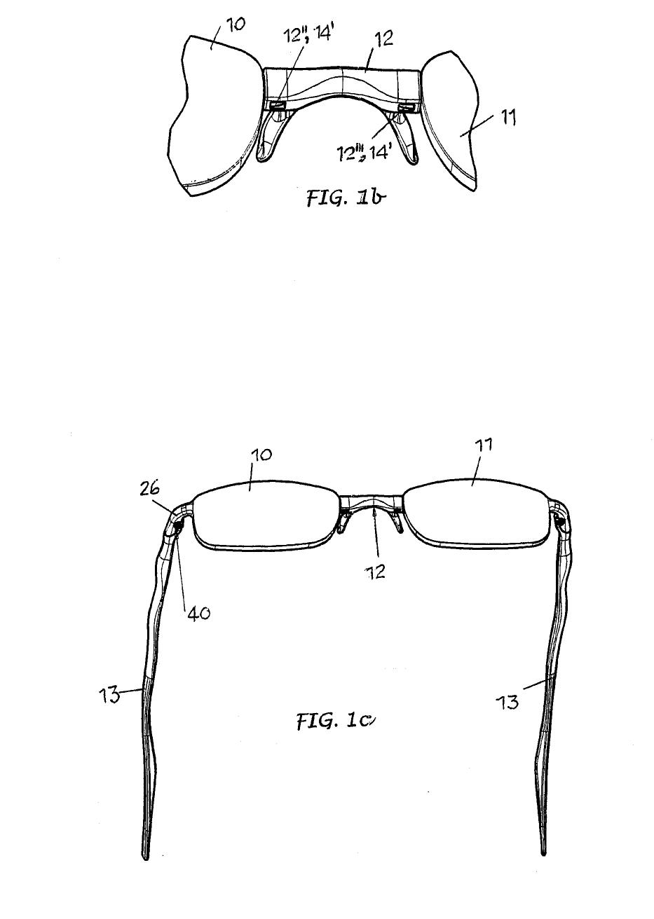

According to another method of manufacturing and as shown in FIGS. 1a-c, the connection element of each lens can be made up of a lug 14, 15 having a lateral connecting tooth 14′, 15′, and the nose bridge 12 has at each of its ends a blind cavity 12′ with a lateral opening 12″. Lugs 14, 15 of the lenses are inserted into the cavities 12′ of the nose bridge 12 to become blocked thanks to the action of their connecting teeth 14′, 15′ in the openings 12″ of the cavities.

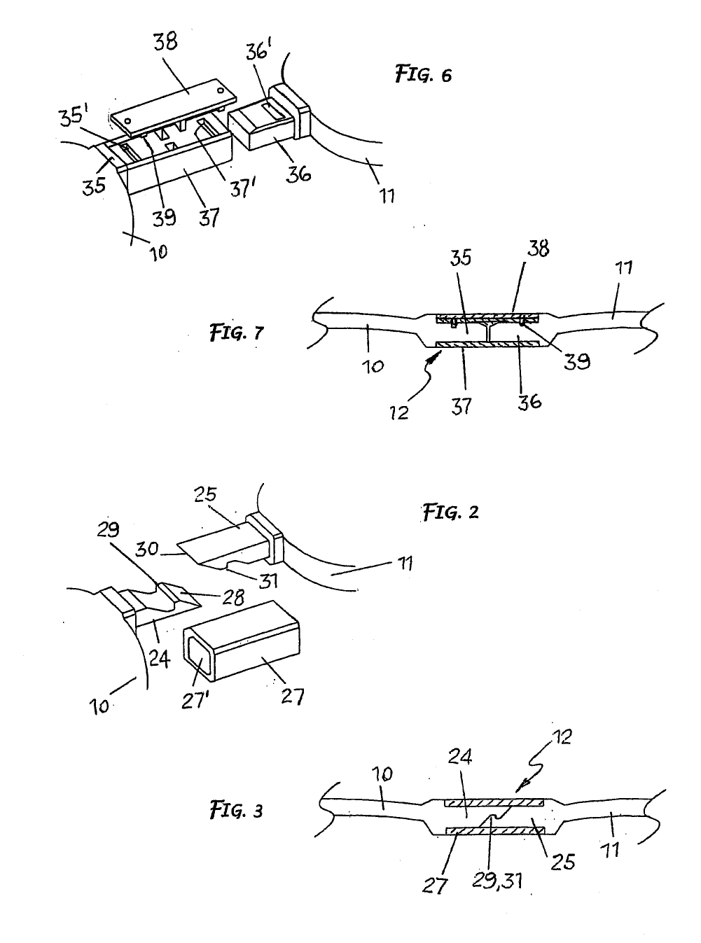

In another form of manufacture, a first lens 10 has on the nose side, a connection element 24—FIG. 2—in the shape of a tang with an end chamfer 28 followed by a connecting tooth 29 along its side. The second lens 11 has a connection element 25 which has a similar shape with an end chamfer 30 and a tooth 31 to engage complementarily with the connecting tooth 29 of the connection element 24 of the first lens.

On the other hand, the nose bridge 12 is made up of a blocking element 27 with a cavity 27′ whose shape and cross section correspond to those of the connection elements 24, 25. Therefore, the two lenses can be constrained to each other by inserting one after the other, from opposite sides, the respective connection elements 24, 25 in the cavity the blocking element 27 so as to make them connect complementarily as shown in FIG. 3. In this way the blocking element will prevent them from uncoupling, thus ensuring a stable and permanent connection of the lenses.

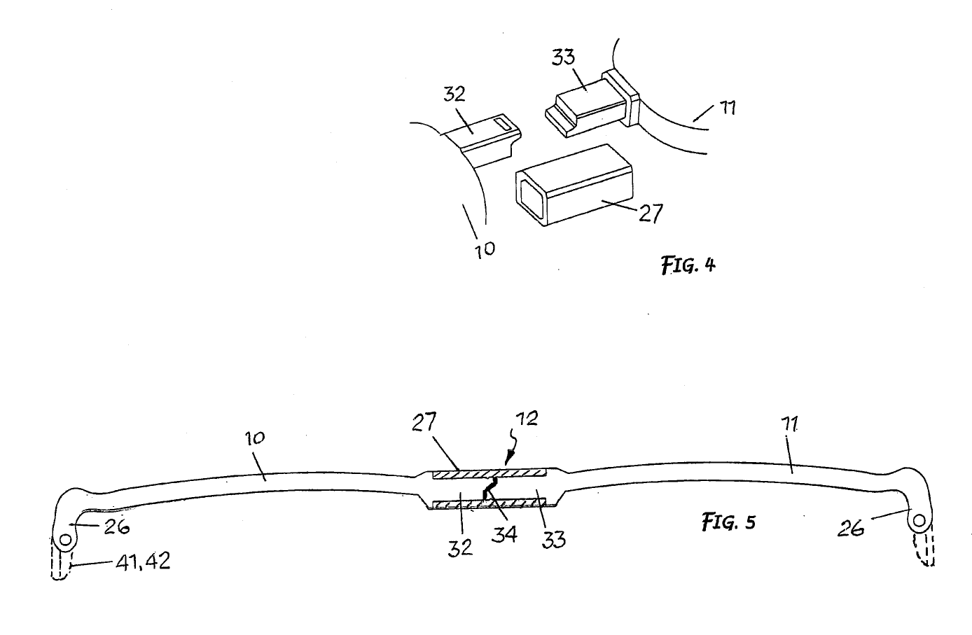

In another example of manufacture—FIG. 4, lenses 10, 11 are equipped on the nose side with connection elements 32, 33 whose free ends are shaped, for example with steps, to fit and self-align when fitted. In this case the connection of the two lenses is achieved by inserting the connection elements 32, 33 into the hollow blocking element 27 until the ends meet, possibly with the placing of a layer of bonding agent 34 to stabilise the connection as shown in FIG. 5. To improve the setting capacity of the bonding agent the surfaces of the connection elements can be rough or grooved.

According to yet another method of manufacture, lenses 10, 11—FIGS. 6 and 7—are equipped on the nose side with connection elements 35, 36 having on at least one side indents or notches 35′, 36′. The connection elements 35, 36 are inserted into a hollow blocking element 37 which has slots 37′ in line with said indents or notches and the connection is then stabilised with an inserted anchoring plate 38, having small teeth 39 which, by passing through the slots of the blocking element, engage with said indents or pressure notches and/or with the layer of bonding agent as shown in FIG. 7.

Evidently and without moving outside the objectives of this invention, to connect the lenses it will be possible to envisage and use connection elements with other and different configurations compared with those illustrated, as long as the connection elements are integral with the lenses and engage, either directly or indirectly, with or without the use of a bonding agent, with an intermediary blocking element made up of, or acting as a nose bridge. Moreover, the coupling of the connection elements to each other and inside the blocking element could be stabilised also with pins inserted crossways in the elements.

Furthermore, the nose bridge can be equipped with integrally cast nose pads or made separately and attached in whatever way to the nose bridge.

The templet 26 on the temple side of each lens is shaped to hinge fit to a relative arm 13 with the help of a pin 40 pressure fitted and held in matching holes provided in the coupled parts of the hinge both of the templet and arm.

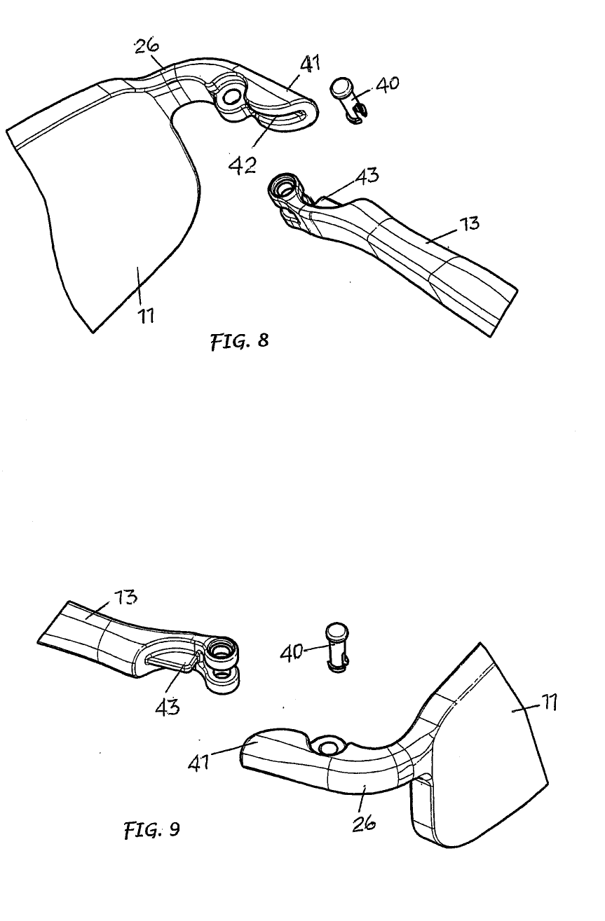

Advantageously as shown in FIGS. 8 and 9 and by dotted lines in FIGS. 1 and 5, each templet 26 extends beyond the axis of the hinge 40 with an extension 41 acting as a support for a similar part of the arm when it is unfolded. The extension 41 of each templet on the side the arm folds towards, can be provided with an indent 42 made to fit into an tooth head 43 provided in the external side of the arm 13 or, on the contrary, extension 41 can have a tooth head and the arm an indent facing towards said tooth head and engaging with it.

In both cases, when the arm 13 is moved from the folded to the unfolded position it rests against extension 41 of its respective templet so that the tooth head 42 and indent 43 connect together and the templet and arm become practically integral so that any incorrect forces applied on the arm will be exerted on the templet section which is far more resistant than the hinge area.

In addition it should be noted that the nose bridge or blocking element, provided and shaped to connect both with the lenses and the arms can be made of the same material as the lenses, transparent or added with colouring pigments, or of another different plastic or metal material so that different styles of spectacles can be accommodated.

In any case, following an appropriate choice of lenses, and as regards to materials and/or colours of the arms and the element forming the nose bridge, it will be possible to create personalised spectacles, also directly by the optician, with a simple and rapid assembly, resulting in spectacles which are extremely adaptable, robust, flexible and foldable, in other words indestructible.

1. Rimless eyeglasses comprising:
a blocking element;
two lenses, each lens being produced by molding, each lens having an integral connection element extending from a nose side of the lens and a templet extending from a temple side of the lens, one connection element of one lens being connected to another connection element of another lens via said blocking element to form a nose bridge; and
two arms, each arm defining a hinge axis, each arm being hingedly connected to one of said templets.

2. Eyeglasses according to claim 1, wherein each lens has a side coupling tooth located on said connection element, said blocking element defining a first cavity and a first side opening located at one end thereof, said blocking element defining a second cavity and a second side opening located at another end thereof, said first cavity receiving one of said connection elements of one of said lens such that said first side opening receives said side coupling tooth of said one of said connection elements, said second cavity receiving another one of said connection elements of another one of said lens such that said second opening receives said side coupling tooth of said another one of said connection elements.

3. Eyeglasses according to claim 1, wherein each connection element has at least one coupling tooth, said blocking element having a through cavity, each connection element being inserted in said through cavity such that each connection element is enclosed in within said blocking element, wherein said connection elements are coupled complementarily to said blocking element, said connection elements being connected to one another within said blocking element via said coupling teeth.

4. Eyeglasses according to claim 1, wherein each connection element has a shaped end, one shaped end of one connection corresponding to another shaped end of another connection element such that said connection elements align with each other, said blocking element defining a through cavity, said connection elements being inserted and housed in said through cavity of the blocking element such that said one shaped end of said one connection element is connected to said another shaped end of said another connection element within said blocking element, said connection elements being attached to said blocking element via a bonding agent.

5. Eyeglasses according to claim 1, wherein each connection element has at least one indent on one side, said blocking element defining slots, said slots being aligned with said indents of said connection elements when said connection elements are inserted and enclosed in said blocking element, said blocking element being associated with an anchoring plate with teeth extending through said slots and mechanically engaging said indents of said connection elements via pressure and/or via a bonding agent when said connection elements are inserted in said blocking element.

6. Eyeglasses according to claim 1, wherein the connection elements of the lenses are held in said blocking element via an additional transversal fastening device.

7. Eyeglasses according to claim 1, wherein said templet of each lens is hingedly connected to one of said arms via a force fitted hinge pin.

8. Eyeglasses according to claim 1, wherein the templet of each lens forms a portion of a hinge, the templet of each lens has an extension extending from the hinge portion to form a lateral support for one of the arms, said extension and a contiguous part of said arm having devices, said devices interlocking the templet of one of said lens with one of said arms when said one of said arms is unfolded, said one of said arms engaging said extension such that said one of said arms is aligned with the templet of one of said lens when said one of said arms is unfolded.

9. Eyeglasses according to claim 8, wherein said extension has a tooth head, each arm having an indent located in an external side thereof for receiving a portion of said extension.

10. Eyeglasses according to claim 7, wherein said extension has an indent and each arm has a tooth head located on an external side thereof for engaging the indent of said extension.

11. Eyeglasses according to claim 1, wherein said blocking element and said arms are composed of the same material as the lenses.

12. Eyeglasses according to claim 1, wherein said blocking element and said arms are made composed of material that is different from the material of the lenses, said blocking element and said arms having a color that is different than a color of said lenses.

13. Eyeglasses according to claim 1, wherein said blocking element is composed of a first material, said arms being composed of a second material, said lenses being composed of a third material, said first material being different from said second material and said third material, said second material being different from said third material, said blocking element having a color that is different than a color of said arms, said lenses having a color that is different than said color of said blocking element and said color of said arms.
